(19) United States
(12) Patent Application Publication
(10) Pub. No.: US 2018/0363845 A1
(43) Pub. Date: Dec. 20, 2018

(54) DEVICE FOR HOLDING A CONTAINER IN AN INVERTED POSITION

(71) Applicant: Sy Maxwell ALIFELD, Atlanta, GA (US)

(72) Inventor: Sy Maxwell ALIFELD, Atlanta, GA (US)

(21) Appl. No.: 16/008,146

(22) Filed: Jun. 14, 2018

Related U.S. Application Data
(60) Provisional application No. 62/519,434, filed on Jun. 14, 2017.

(51) Int. Cl. F16M 13/02; F16B 47/00

(52) U.S. Cl. CPC F16M 13/022; F16M 2200/06; F16B 47/006

(57) ABSTRACT

A device for holding a container in an inverted position or holding another item, that includes a grasping assembly, wherein the grasping assembly further includes a plurality of flexible, articulated grasping members; an elbow adapted to receive the plurality of flexible, articulated grasping members in the grasping assembly; and a mounting assembly attached to the elbow, wherein the mounting assembly includes a suction cup for attaching the device to a vertical surface.

### CROSS-REFERENCE TO RELATED APPLICATIONS

This patent application claims the benefit of U.S. Provisional Patent Application Ser. No. 62/519,434 filed on Jun. 14, 2017 and entitled “Apparatus for Removably Grasping and Suspending a Container” the disclosure of which is hereby incorporated by reference herein in its entirety and made part of the present U.S. utility patent application for all purposes.

### BACKGROUND OF THE INVENTION

The described invention relates in general to systems, methods, and devices for holding containers, and more specifically to a device for holding containers of various types, sizes, and dimensions in an inverted position for facilitating removal of viscous fluids from the containers. This invention may also be used to hold items other than containers.

Containers designed for holding liquid contents, particularly viscous liquids such as soap and shampoo or similar liquids or fluids, or condiments, often include a dispensing opening that is positioned at the top of the container. Such containers require a user thereof to invert the container to dispense its contents. When the container is nearly empty it becomes increasingly inconvenient for the user to wait until the viscous liquid slowly drains down to the opening so that it can be squeezed or otherwise forced out of the container. Typically, to allow the contents of the container to settle or drain toward the opening, the container is inverted and balanced on the opening end, which often is not adapted to permit the container to stand easily or in a stable manner. The container is often propped against a wall or other vertical surface but may slip or fall over. Accordingly, there is an ongoing need for a device or apparatus that can be attached to a vertical surface and that can grasp a variety of container types in an inverted position for facilitating the removal or dispensing of viscous fluids therefrom.

### SUMMARY OF THE INVENTION

The following provides a summary of certain exemplary embodiments of the present invention. This summary is not an extensive overview and is not intended to identify key or critical aspects or elements of the present invention or to delineate its scope. However, it is to be understood that the use of indefinite articles in the language used to describe and claim the present invention is not intended in any way to limit the described system. Rather the use of “a” or “an” should be interpreted to mean “at least one” or “one or more”.

In accordance with one aspect of the present invention, a first device for holding a container in an inverted position or holding another item, is provided. This device includes a grasping assembly, wherein the grasping assembly further includes a plurality of flexible, articulated grasping members; an elbow adapted to receive the plurality of flexible, articulated grasping members in the grasping assembly; and a mounting assembly attached to the elbow, wherein the mounting assembly includes a suction cup for attaching the device to a vertical surface.

In accordance with another aspect of the present invention, a second device for holding a container in an inverted position or holding another item, is provided. This device includes a grasping assembly, wherein the grasping assembly further includes a plurality of flexible, articulated grasping members and wherein a portion of each flexible, articulated grasping member is covered with a rubberized material; a flexible ring to which one end of each of the flexible, articulated grasping members is attached; an elbow adapted to receive the grasping assembly; and a mounting assembly attached to the elbow, wherein the mounting assembly includes a suction cup for attaching the device to a vertical surface.

In yet another aspect of this invention, a third device for holding a container in an inverted position or holding another item is provided. This device includes a grasping assembly, wherein the grasping assembly further includes a plurality of flexible grasping members, wherein each flexible grasping member in the plurality of flexible grasping members further includes a first end that further includes a hook structure formed thereon; a second end that further includes a locking tab formed thereon; a length of flexible material disposed between the first and second ends of the grasping member and a sleeve of gripping material positioned along the length of flexible material disposed between the first and second ends; and a ring of flexible material secured by the hook structures formed in the first ends of the grasping members; a collar, wherein the collar further includes a plurality of slots formed therein, and wherein each slot in the plurality of slots has been adapted to receive the second end of a grasping member and to engage the locking tab formed thereon; an elbow, wherein the elbow further includes a first opening and a second opening formed therein, and wherein the first opening has been adapted to receive the collar; and a mounting assembly. The mounting assembly further includes a circular base having an aperture formed therein; a stem formed integrally with the circular base and having an aperture formed therein, wherein the second opening in the elbow has been adapted to receive the stem therein; an attachment member for attaching the stem to the elbow; a suction cup, wherein the suction cup further includes a release tab formed thereon and a stem formed thereon, and wherein the stem is adapted to protrude through the aperture formed in the circular base; and an actuator mounted on the stem of the suction cup for applying and releasing pressure to the suction cup.

Additional features and aspects of the present invention will become apparent to those of ordinary skill in the art upon reading and understanding the following detailed description of the exemplary embodiments. As will be appreciated by the skilled artisan, further embodiments of the invention are possible without departing from the scope and spirit of the invention. Accordingly, the drawings and associated descriptions are to be regarded as illustrative and not restrictive in nature.

### BRIEF DESCRIPTION OF THE DRAWINGS

The accompanying drawings, which are incorporated into and form a part of the specification, schematically illustrate one or more exemplary embodiments of the invention and, together with the general description given above and detailed description given below, serve to explain the principles of the invention, and wherein:

FIG. 1 is a front, perspective view of a device for holding a container in an inverted position, in accordance with an exemplary embodiment of the present invention;

FIG. 2 is a side view of the device of FIG. 1; and

FIG. 3 is an exploded view of the device of FIGS. 1 and 2.

### DETAILED DESCRIPTION OF THE INVENTION

Exemplary embodiments of the present invention are now described with reference to the Figures. Reference numerals are used throughout the detailed description to refer to the various elements and structures. Although the following detailed description contains many specifics for the purposes of illustration, a person of ordinary skill in the art will appreciate that many variations and alterations to the following details are within the scope of the invention. Accordingly, the following embodiments of the invention are set forth without any loss of generality to, and without imposing limitations upon, the claimed invention.

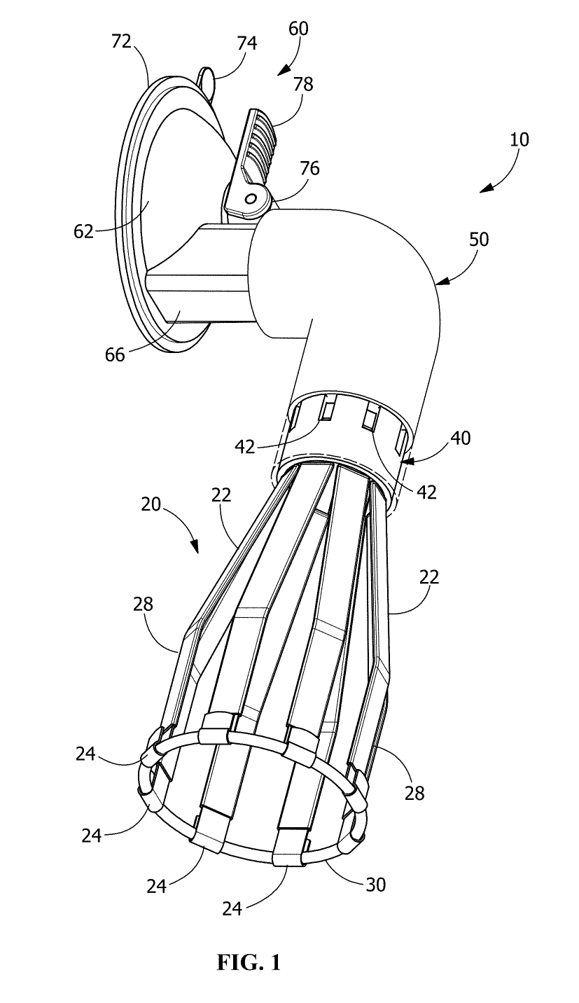

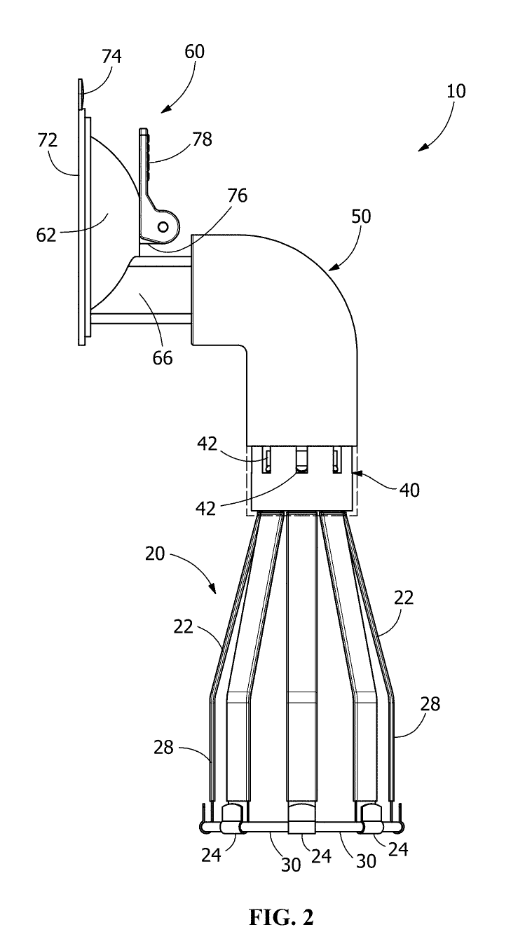

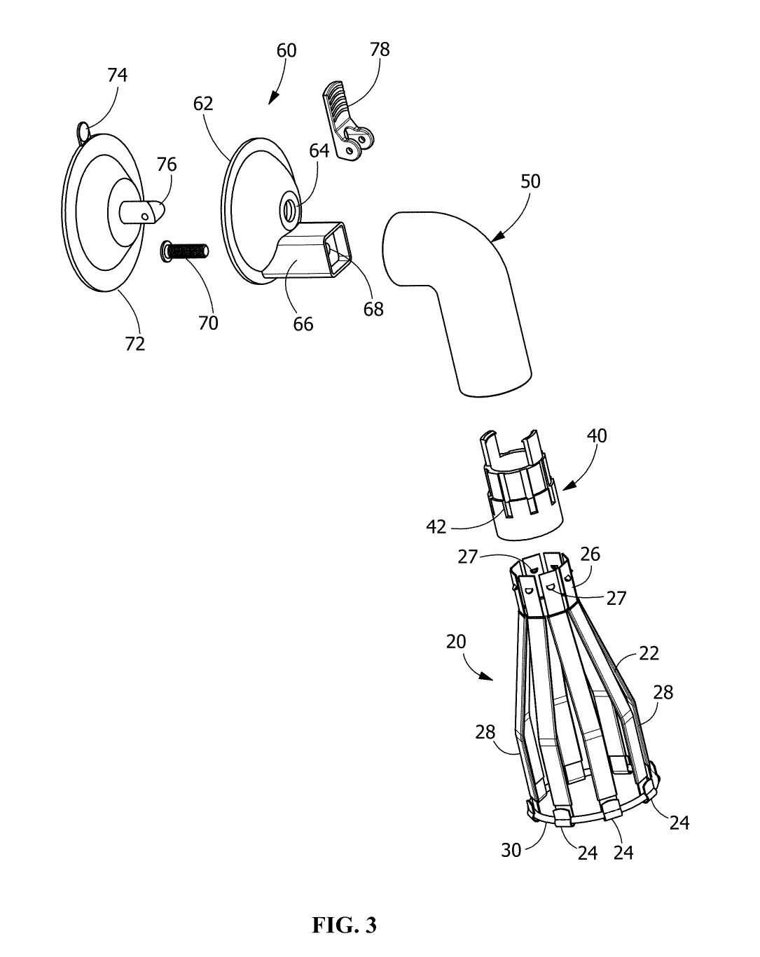

With reference to the Figures, FIG. 1 provides a front, perspective view of a device for holding a container in an inverted position, in accordance with an exemplary embodiment of the present invention; FIG. 2 provides a side view of the device of FIG. 1; and FIG. 3 provides an exploded view of the device of FIGS. 1 and 2. In the exemplary embodiments shown in the Figures, container grasping device 10 includes grasping assembly 20, mounting collar 40 (which is optional and not included in some embodiments); elbow 50; and mounting assembly 60. Grasping assembly 20 is adapted to hold a variety of container types and sizes based on the ability of grasping assembly 20 to expand and contract. Grasping assembly 20 includes a plurality (e.g., eight) of flexible, articulated grasping members 22 that form a wide circular opening at one end thereof and a narrower opening at the other end thereof. Each flexible, articulated grasping member 22 includes a hook structure 24 formed on one end thereof. The opposite or mounting end 26 of each flexible, articulated grasping member 22 includes a locking tab 27 formed thereon. Articulated grasping members 22 may be thin metal structures or may be made from plastic or other flexible and resilient material. A rubberized or elastomeric gripping sleeve 28 is mounted on the middle portion of each flexible, articulated grasping member 22 for providing additional grasping functionality. Each hook structure 24 wraps around and secures a portion of flexible ring 30, which may be made of a spring-like device or from rubber or plastic. When a container is inserted into container grasping device 10, flexible ring 30 and grasping assembly 20 initially expand to receive the container, then contract to secure the container within grasping assembly 20. Because flexible, articulated grasping members 22 can move independently of one another, grasping assembly 20 can grasp articles of different sizes and shapes, such as, but not limited to, cylindrical, square, rectangular, and/or elliptical. In certain embodiments, this invention is used to hold items such a cell phones, tablet devices, or the like and in other embodiments, this device is adapted to hold a baby bottle and be attached to a stroller.

Collar 40 includes a plurality of slots 42 formed therein and each slot 42 is adapted to receive mounting end 26 of each flexible, articulated grasping member 22 and securely engage locking tab 27. Collar 40 is then completely inserted into one end of elbow 50 (see the broken lines in FIGS. 1-2). In some embodiments of this invention, mounting ends 26 are mounted directly into the interior of elbow 50 and collar 40 is not present. Elbow 50 typically includes a first end and a second end that are positioned at a 90° angle relative to one another, although in other embodiments different angles are used. In still other embodiments (not shown in the Figures), a hinge or ball joint is included in elbow 50 for allowing the user to change or modify the angle at which the container hangs.

Exemplary mounting assembly 60 permits a user of container grasping device 10 to attach the device to a wall or other vertical surface in a non-permanent detachable manner. Mounting assembly 60 includes circular base 62, which includes aperture 64 and stem 66. Stem 66 also includes aperture or bore 68, which is formed therein. Connecting member or bolt 70 is used to connect base 62 to elbow 50. Diaphragm or suction cup 72 includes release tab 74 and stem 76, which is inserted through aperture 64. Actuator 78 is attached to stem 76 in a hinged manner and is used to apply force to suction cup 72 or to release suction cup 72 from a surface to which it has been attached. Release tab 74 is used to remove the entire container grasping device 10 from a wall or other surface. Other mounting assemblies such as brackets and the like may be used with the present invention to secure the device in a more permanent manner to the surface upon which it is mounted.

While the present invention has been illustrated by the description of exemplary embodiments thereof, and while the embodiments have been described in certain detail, there is no intention to restrict or in any way limit the scope of the appended claims to such detail. Additional advantages and modifications will readily appear to those skilled in the art. Therefore, the invention in its broader aspects is not limited to any of the specific details, representative devices and methods, and/or illustrative examples shown and described. Accordingly, departures may be made from such details without departing from the spirit or scope of the general inventive concept.

What is claimed:

1. A device for holding a container in an inverted position or holding another item, comprising:
(a) a grasping assembly, wherein the grasping assembly further includes a plurality of flexible, articulated grasping members;
(b) an elbow adapted to receive the plurality of flexible, articulated grasping members in the grasping assembly; and
(c) a mounting assembly attached to the elbow, wherein the mounting assembly includes a suction cup for attaching the device to a vertical surface.

2. The device of claim 1, further comprising a flexible ring to which one end of each of the flexible, articulated grasping members is attached.

3. The device of claim 1, wherein a portion of each flexible, articulated grasping member is covered with a sleeve of rubberized or elastomeric material.

4. The device of claim 1, wherein the elbow includes a first end portion and a second end portion positioned at a 90° angle relative to one another.

5. The device of claim 4, wherein the mounting assembly further includes a base to which the suction cup is attached, and wherein the base further includes a stem that is adapted to be coupled to the second end portion of the elbow.

6. The device of claim 1, wherein the flexible, articulated grasping members are made from metal, plastic, or a combination thereof.

7. A device for holding a container in an inverted position or holding another item, comprising:
(a) a grasping assembly, wherein the grasping assembly further includes a plurality of flexible, articulated grasping members and wherein a portion of each flexible, articulated grasping member is covered with a rubberized material;
(b) a flexible ring to which one end of each of the flexible, articulated grasping members is attached;
(c) an elbow adapted to receive the grasping assembly; and
(d) a mounting assembly attached to the elbow, wherein the mounting assembly includes a suction cup for attaching the device to a vertical surface.

8. The device of claim 7, wherein each flexible, articulated grasping member in the plurality of flexible, articulated grasping members further includes:
(a) a first end, wherein the first end further includes a hook structure formed thereon, and wherein the hook structure is adapted to engage the flexible ring; and
(ii) a second end, wherein the second end further includes a locking tab formed thereon.

9. The device of claim 8, further comprising a collar, wherein the collar further includes a plurality of slots formed therein, and wherein each slot in the plurality of slots has been adapted to receive the second end of a grasping member and to engage the locking tab formed thereon.

10. The device of claim 8, wherein the elbow includes a first end portion and a second end portion positioned at a 90° angle relative to one another, and wherein the first end portion is adapted to receive the collar.

11. The device of claim 8, wherein the mounting assembly further includes a base to which the suction cup is attached, and wherein the base further includes a stem that is adapted to be coupled to the second end portion of the elbow.

12. The device of claim 8, wherein the suction cup includes a stem that protrudes through an aperture formed in the base and to which an actuator is attached for applying force to the suction cup for facilitating attachment of the suction cup to a vertical surface.

13. The device of claim 8, wherein the flexible, articulated grasping members are made from metal, plastic, or a combination thereof.

14. A device for holding a container in an inverted position or holding another item, comprising:
(a) a grasping assembly, wherein the grasping assembly further includes:
(i) a plurality of flexible grasping members, wherein each flexible grasping member in the plurality of flexible grasping members further includes:
a) a first end, wherein the first end further includes a hook structure formed thereon;
b) a second end, wherein the second end further includes a locking tab formed thereon;
c) a length of flexible material disposed between the first and second ends of the grasping member; and
d) a sleeve of gripping material positioned along the length of flexible material disposed between the first and second ends; and
(ii) a ring of flexible material secured by the hook structures formed in the first ends of the grasping members;
(b) a collar, wherein the collar further includes a plurality of slots formed therein, and wherein each slot in the plurality of slots has been adapted to receive the second end of a grasping member and to engage the locking tab formed thereon;
(c) an elbow, wherein the elbow further includes a first opening and a second opening formed therein, and wherein the first opening has been adapted to receive the collar; and
(d) a mounting assembly, wherein the mounting assembly further includes:
(i) a circular base having an aperture formed therein;
(ii) a stem formed integrally with the circular base and having an aperture formed therein, wherein the second opening in the elbow has been adapted to receive the stem therein;
(iii) an attachment member for attaching the stem to the elbow;
(iv) a suction cup, wherein the suction cup further includes a release tab formed thereon and a stem formed thereon, and wherein the stem is adapted to protrude through the aperture formed in the circular base; and
(v) an actuator mounted on the stem of the suction cup for applying and releasing pressure to the suction cup.

15. The device of claim 14, further comprising a joining member for attaching the stem on the circular base to the elbow.

16. The device of claim 14, wherein each grasping member is articulated.

17. The device of claim 14, wherein the grasping members are made from metal, plastic, or a combination thereof.

18. The device of claim 14, wherein the ring of flexible material includes a spring-like material.

19. The device of claim 14, wherein the ring of flexible material includes rubber or polymer.

20. The device of claim 14, wherein the elbow includes a first end portion and a second end portion positioned at a 90° angle relative to one another.
